(19) United States
(12) Patent Application Publication
(10) Pub. No.: US 2004/0119250 A1
(43) Pub. Date: Jun. 24, 2004

(54) Spring arrangement including a spring and shock absorber assembly

(76) Inventors: Gunter Rehra, Wedemark (DE); Wolfgang Schmidt, Garbsen (DE)

Correspondence Address: Walter Ottesen, Patent Attorney, P.O. Box 4026, Gaithersburg, MD, 20885-4026, US

(21) Appl. No.: 10/725,038

(22) Filed: Dec. 2, 2003

(30) Foreign Application Priority Data
Dec. 6, 2002 (DE) 102 57 008.6

(51) Int. Cl. B60G 17/005

(52) U.S. Cl. 280/5.507

(57) ABSTRACT

An air spring and shock absorber assembly (22) includes an air spring (4) and a shock absorber (24). The assembly further includes a level control unit (18) in addition to an elevation sensor (20) for determining and adjusting the spring elevation (hₓ) between the two end positions (h₁, h₂) and also includes a damper control (34) for adjusting the damping hardness given by the friction coefficient (ρₓ) In order to avoid impacts against the end-position buffers (38) also in the deflected or extended state, the friction coefficient (ρₓ) of the damper (24) is a function of the particular measured spring height (hₓ). The damper characteristic line ρₓ=f(hₓ) is characterized by an increase of the friction coefficient (ρₓ) in the direction toward at least one of the end positions (h₁, h₂) of the spring (4). The damper hardening can be realized with the aid of a pressure increase in the damper (24) in the case of an air damper.

### FIELD OF THE INVENTION

The invention relates to a spring arrangement which includes a spring and shock absorber assembly adjustable in elevation.

### BACKGROUND OF THE INVENTION

For the most extreme deflections and for emergency situations (for example, a defective air spring) such air spring and shock absorber assemblies usually include end position buffers as stops, that is, as supports. In the deflected or expanded position of the air spring and shock absorber assembly, the end position buffers are already touched with slight spring deflections. The contact engagement against the end position buffers means a considerable reduction in driving comfort. Furthermore, the repeated impact over time is associated with high wear.

### SUMMARY OF THE INVENTION

It is an object of the invention to provide a spring and shock absorber assembly which is adjustable in elevation and wherein an impact against one or both end position buffers is reliably avoided in the deflected state or in the expanded state.

The spring arrangement of the invention includes: a plurality of spring and shock absorber assemblies; each of the springs of the assemblies having first and second end positions (h₁, h₂) and being characterized by a maximum spring deflection (Δh=h₂−h₁); level control unit assigned to the springs of the assemblies; sensor means operatively connected to corresponding ones of the springs; the level control unit and the sensor means coacting to determine and adjust the spring elevation (hₓ) between the first and second end positions; the shock absorbers of the assemblies having respective coefficients of friction (ρₓ); a shock absorber control unit connected to the shock absorbers of corresponding ones of the assemblies to adjust the damping hardness given by the corresponding coefficient of friction (ρₓ); and, the friction coefficient (ρₓ) of each one of the shock absorbers being a function of the spring elevation (hₓ) measured for the spring associated therewith (ρₓ=f(hₓ)

In the foregoing, it can be seen that the object of the invention is achieved in that the damper force or the friction coefficient ρₓ of the shock absorber is controllable in dependence upon the elevation position hₓ of the air spring. Accordingly, the increase of the damping force or of the coefficient of friction ρₓ of the shock absorber in the end positions of the assembly is defined as a function of the measured elevation hₓ of the air spring and shock absorber assembly.

Preferably, the individual shock absorbers are so controlled in dependence upon the position of the particular air spring that the damping force is increased in at least one of the end positions, that is, the damping force of the shock absorber is increasingly hardened in the close-in range of the at least one end position.

The nonlinear characteristic line of the function is defined by a support position table which can be vehicle-specifically parameterized in accordance with pull and press stages. The pull and press stops of the air spring and shock absorber assembly are protected against damage from forces which are too large because of such an end position hardening. End position buffers can therefore be substantially eliminated.

The end position control unit according to the invention can be a supplementary component of an air spring and shock absorber assembly control and can act in a superposing manner thereto.

An elevation displacement is easy to realize especially in air springs. For this reason, an influencing of the damping force in accordance with the invention is preferably considered with respect to air spring and shock absorber assemblies.

When the shock absorber is a pressure shock absorber, then the damper hardening in the end regions can be realized by means of a pressure increase in the shock absorber. The pressure adaptation is preferably generated with the aid of a pressure converter.

### BRIEF DESCRIPTION OF THE DRAWINGS

The invention will now be described with reference to the drawings wherein:

FIG. 1 is a schematic of an air spring system of a motor vehicle;

FIG. 2 is a longitudinal section of an air spring and shock absorber assembly;

FIG. 3 is a plot of the damping force according to the invention plotted as a function of the spring excursion;

FIG. 4a is a simplified electric block circuit diagram for the control of the air spring and shock absorber assembly in accordance with the state of the art; and,

FIG. 4b is an electric block circuit diagram for the control of an air spring system incorporating a damper control in accordance with the invention.

### DESCRIPTION OF THE PREFERRED EMBODIMENTS OF THE INVENTION

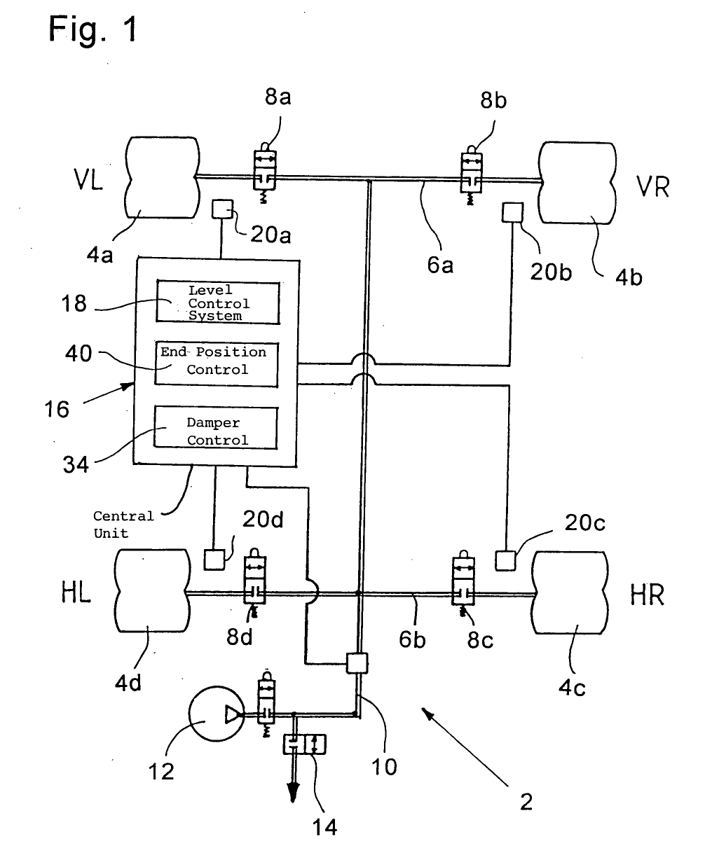

The air spring system 2 of a motor vehicle shown in FIG. 1 includes four air springs (4a, 4b, 4c, 4d) which are assigned to corresponding axles or wheels of the motor vehicle.

Two of the air springs (4a, 4b) are connected to each other via a first transverse line 6a and the two other air springs (4c, 4d) are connected to each other via a second transverse line 6b. The transverse line 6a includes two transverse check valves (8a, 8b) and transverse line 6b includes two transverse check valves (8c, 8d). The transverse check valves (8a, 8b, 8c, 8d) correspond to respective ones of the air springs (4a, 4b, 4c, 4d). Furthermore, the transverse lines (6a, 6b) are connected to a further line 10 via which the air springs 4a to 4d are filled with pressurized air with the aid of a compressor 12 or via which pressurized air can be released to the atmosphere via an additional valve 14. For this purpose, the control inputs of the corresponding valves 8a to 8d and the compressor 12 are controlled by a central unit 16 equipped with a level control unit 18. With the aid of the sensed elevation signals, the level control unit 18 can control the elevation of the vehicle body to a desired level independently of the state of loading.

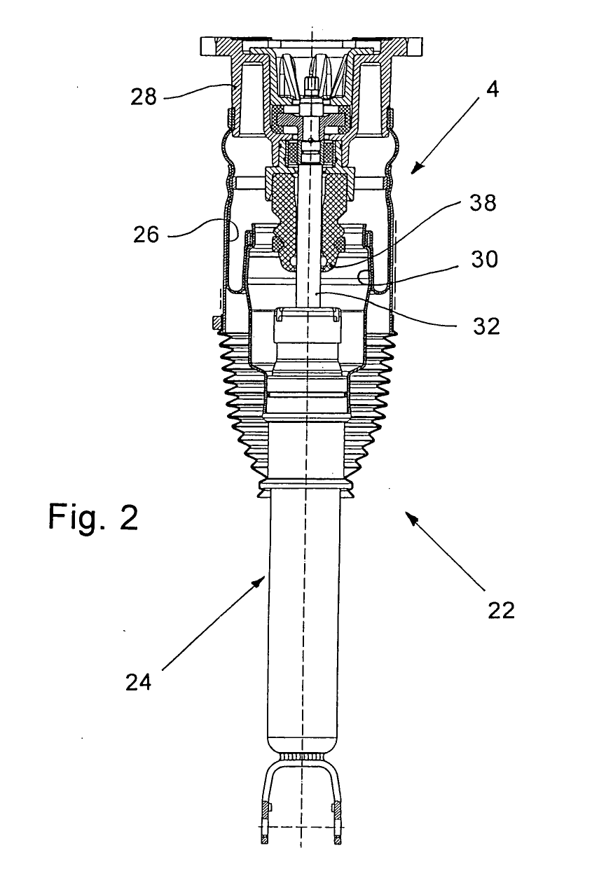

The air spring and shock absorber assembly 22 of FIG. 2 comprises the air spring 4 with the integrated shock absorber 24.

The air spring 4 includes a cylindrical tubular flexible member 26 made of elastomeric material. The upper end of the flexible member 26 is closed off pressure-tight by the cover 28 and is attached to the chassis (not shown) of the motor vehicle.

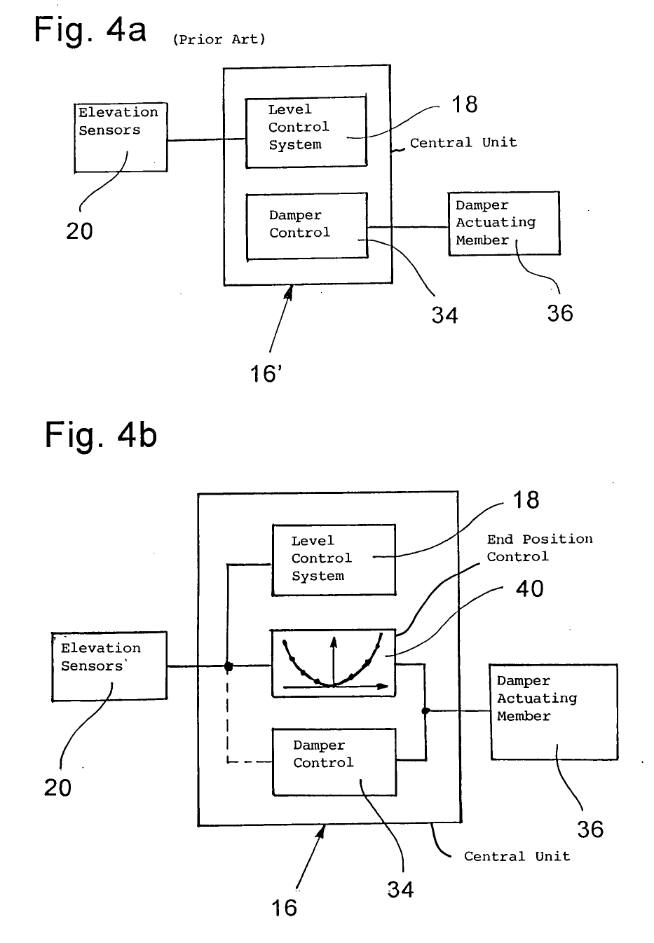

The lower end of the flexible member 26 is attached to a roll-off piston 30 which is mounted at the wheel end via the housing of the shock absorber 24. The piston 32 of the shock absorber 24 is mounted on the chassis. The shock absorber 24 includes a damper control 34 (see FIGS. 1 and 4) having a damper actuating member 36 (FIG. 4).

For the most extreme spring deflections, the air spring and shock absorber assembly 22 is equipped with an end position buffer 38.

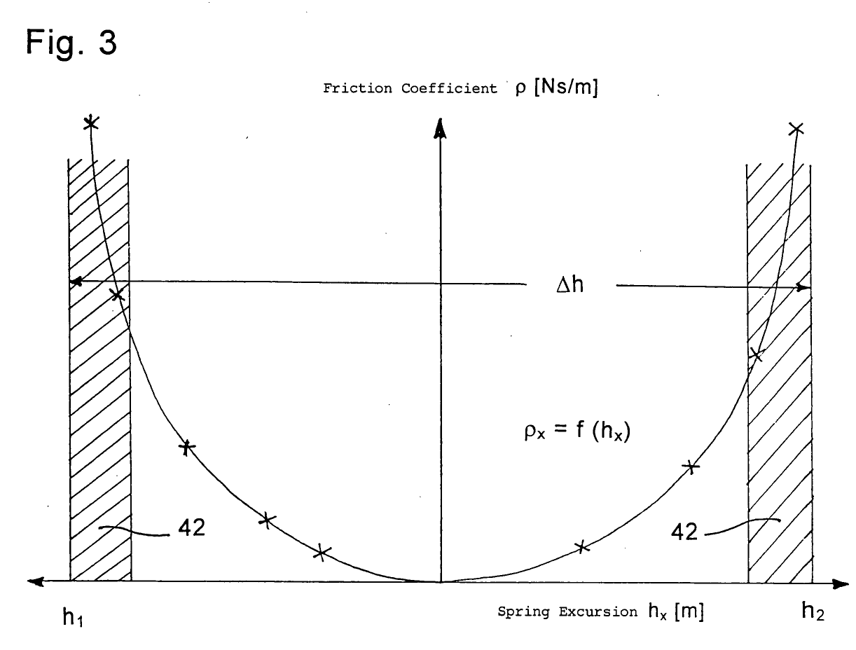

The diagram of FIG. 3 shows the damping force (more precisely, the friction coefficient ρₓ) relative to the spring excursion (the spring elevation hₓ). Thus, the curve in FIG. 3 is defined by the equation:

ρₓ=f(hₓ).

As shown in FIG. 3, the friction coefficient ρₓ increases progressively in the direction toward the end positions (h₁, h₂) (maximum spring stroke Δh=h₂−h₁) of the air spring 4 in accordance with the invention and increases greatly in the regions 42 close to the end positions (h₁, h₂).

The block circuit diagram of FIG. 4a shows a component “damper control” 34 which is operatively connected to a damper actuating member 36. This damper actuating member 36 is the executing element for changing the damping force, more specifically, for changing the friction coefficient ρₓ of the particular damper 24. Except for a damper control unit 34 and a damper actuating member 36, the central unit 16′ shown here includes the electronics of the level control unit 18 which can process the signals, which are received from the elevation sensors (20a, 20b, 20c, 20d) for the purpose of adjusting the desired level. In FIGS. 4a and 4b, reference numeral 20 identifies the elevations sensors (20a, 20b, 20c, 20d) collectively.

Compared to the conventional circuit arrangement shown in FIG. 4a, the circuit arrangement of the invention shown schematically in FIG. 4b includes essential features, namely: the component “damper control” 34 is supplemented by a component “end position control” 40. The end-position control 40 exhibits the damper force characteristic line ρₓ=f(hₓ) shown in FIG. 3. This characteristic line is characterized by a progressive increase of the damping force (friction coefficient ρₓ) in a direction toward the end positions (h₁, h₂) of the air spring 4.

In order to be able to output a control signal ρₓ, which corresponds to the spring elevation hₓ, to the damper actuating member 36, the end-position control 40 is operatively connected to the elevation sensors 20.

For the case of an active damping control, the component “damper control” 34 likewise is connected to the elevation sensors 20 (see the broken line in FIG. 4b).

To control the damping force, the signals outputted by the damper control 34 and the end-position control 40 are outputted to the damper actuating member 36. With the aid of the end-position control 38 according to the invention, an end-position buffer 40 (see FIG. 2) can be omitted.

It is understood that the foregoing description is that of the preferred embodiments of the invention and that various changes and modifications may be made thereto without departing from the spirit and scope of the invention as defined in the appended claims.

What is claimed is:

1. A spring arrangement comprising:
a plurality of spring and shock absorber assemblies;
each of said springs of said assemblies having first and second end positions (h₁, h₂) and being characterized by a maximum spring deflection (Δh=h₂−h₁);
level control unit assigned to the springs of said assemblies;
sensor means operatively connected to corresponding ones of said springs;
said level control unit and said sensor means coacting to determine and adjust the spring elevation (hₓ) between said first and second end positions;
said shock absorbers of said assemblies having respective coefficients of friction (ρₓ);
a shock absorber control unit connected to the shock absorbers of corresponding ones of said assemblies to adjust the damping hardness given by the corresponding coefficient of friction (ρₓ); and,
the friction coefficient (ρₓ) of each one of said shock absorbers being a function of the spring elevation (hₓ) measured for the spring associated therewith (ρₓ=f(hₓ).

2. The spring arrangement of claim 1, wherein a shock absorber characteristic line (ρₓ=f(hₓ)) is characterized by an increase of said friction coefficient (ρₓ) in a direction toward at least one of said end positions (h₁, h₂).

3. The spring arrangement of claim 1, wherein there is a progressive increase of the damping hardness in the close in region of at least one of said end positions (h₁ and/or h₂).

4. The spring arrangement of claim 1, further comprising an end-position control unit having an output coupled to the output of said shock absorber control unit.

5. The spring arrangement of claim 2, wherein said characteristic line (ρₓ) is non-linear and is given by a support location table which is separately parameterized for a specific vehicle in accordance with pull and press steps.

6. The spring arrangement of claim 1, wherein said spring is an air spring.

7. The spring arrangement of claim 1, wherein said shock absorber is an air shock absorber.

8. The spring arrangement of claim 7, wherein the damping hardness of said air shock absorber is realized by a pressure increase therein.

9. The spring arrangement of claim 8, further comprising a pressure converter for realizing the pressure adaptation in the air shock absorber.
